(19) United States
(12) Patent Application Publication
(10) Pub. No.: US 2013/0109360 A1
(43) Pub. Date: May 2, 2013

(54) METHOD FOR REDUCING EFFECT OF ELECTROMAGNETIC RADIATION ON A USER OF A MOBILE PHONE

(71) Applicant: Jung-Tsung Wei, Tainan City (TW)

(72) Inventor: Jung-Tsung Wei, Tainan City (TW)

(73) Assignee: JINGLE WORLD CO., LTD., Tainan City (TW)

(21) Appl. No.: 13/666,769

(22) Filed: Nov. 1, 2012

(30) Foreign Application Priority Data
Nov. 1, 2011 (TW) 100139783
Feb. 15, 2012 (TW) 101104913

(51) Int. Cl. H04W 68/00; H04W 4/12

(52) U.S. Cl. 455/412.2; 455/419

(57) ABSTRACT

A method is for reducing effect, on a user of a mobile phone, of electromagnetic radiation emitted from the mobile phone. In the method, the mobile phone is operable to configure a processing unit thereof to process an incoming telecommunication signal, to configure an active delay unit to actively disable a notifying unit by a predetermined latent time, and to configure the active delay unit to enable the notifying unit to output an incoming notifying signal for notifying the user of an incoming call after the predetermined latent time has elapsed.

### CROSS-REFERENCE TO RELATED APPLICATION

This application claims priority of Taiwanese Application No. 100139783, filed on Nov. 1, 2011, and Taiwanese Application No. 101104913, filed on Feb. 15, 2012.

### BACKGROUND OF THE INVENTION

1. Field of the Invention

The invention relates to a method for reducing effect of electromagnetic radiation on a user of a mobile phone.

2. Description of the Related Art

The mobile phone has become very prominent in daily lives as an instrument for communication. However, electromagnetic radiation is constantly emitted from the mobile phone during use, and may have hazardous effect to human health. Thus, it is preferable to place the mobile phones apart from a head of a user of the mobile phone when the electromagnetic radiation emitted from the mobile phone has a relatively higher flux (i.e., when a number is Inst dialed using the mobile phone, or when an incoming call is inst received by the mobile phone). However, the user usually ignores or is unaware of such time and may unknowingly expose his/her head to the high electromagnetic radiation flux.

### SUMMARY OF THE INVENTION

Therefore, the object of the present invention is to provide a method for reducing effect of electromagnetic radiation, on a user of a mobile phone by notifying the user to avoid putting the mobile phone near his/her head during the time in which electromagnetic radiation emitted from the mobile phone has a relatively higher flux.

According to one aspect, a method of the present invention is for reducing effect, on a user of a mobile phone, of electromagnetic radiation emitted from the mobile phone. The mobile phone includes a communication unit for communicating with a wireless telecommunication provider, a processing unit, an active delay unit and a notifying unit. The method comprises the following steps of:

when the communication unit of the mobile phone receives an incoming telecommunication signal from the wireless telecommunication provider, configuring the processing unit to process the incoming telecommunication signal;

configuring the active delay unit to actively disable the notifying unit by a predetermined latent time; and

configuring the active delay unit to enable the notifying unit to output an incoming notifying signal for notifying the user of an incoming call associated with the incoming telecommunication signal after the predetermined latent time has elapsed.

According to another aspect, a method of the present invention is for reducing effect, on a user of a mobile phone, of electromagnetic radiation emitted from the mobile phone. The mobile phone includes a communication unit for communicating with a transceiving device through a wireless telecommunication provider, and a notifying unit. The method comprises the following step of:

configuring the notifying unit of the mobile phone to output an alerting signal immediately, after the user dials a number for communicating with the transceiving device using the mobile phone.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a mobile phone for implementing a method for reducing effect of electromagnetic radiation on a user of a mobile phone according to the invention;

FIG. 2 is a flow chart of a first preferred embodiment of the method for reducing effect of electromagnetic radiation on a user of a mobile phone according to the invention; and

FIG. 3 is a flow chart of a second preferred embodiment of the method according to the invention.

### DETAILED DESCRIPTION OF THE PREFERRED EMBODIMENTS

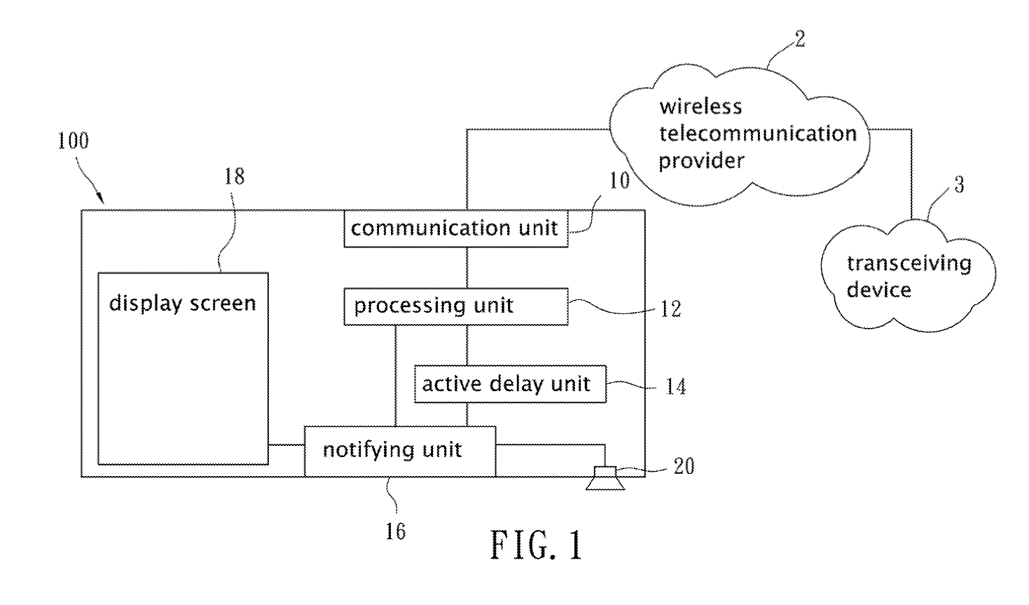

FIG. 1 illustrates a mobile phone 100 for implementing a method for reducing effect of electromagnetic radiation on a user of the mobile phone 100 from according to the present invention. The mobile phone 100 includes a communication unit 10 for communicating with a wireless telecommunication provider 2, a processing unit 12, an active delay unit 14, a notifying unit 16, a display screen 18 and a speaker 20. The communication unit 10 of the mobile phone 100 is configured to receive an incoming telecommunication signal, which is associated with an incoming call from a transceiving device 3, from the wireless telecommunication provider 2, and to transmit a receipt signal, which indicates that the mobile phone 100 has received the incoming telecommunication signal, to the wireless telecommunication provider 2. The incoming telecommunication signal may be incorporated with a voice message and/or a display image from the wireless telecommunication provider 2. In some examples, the voice message and/or the display image may be, for example, instant weather report, advertisement provided by the wireless telecommunication provider 2, etc. The notifying unit 16 is configured to output an incoming notifying signal (e.g., ringtone, vibration, etc.) via the display screen 18 and/or the speaker 20 for notifying the user of the incoming call associated with the incoming telecommunication signal when the mobile phone 100 serves as a call recipient. In the case where the user uses the mobile phone 100 to dial a number of the transceiving device 3, i.e., the mobile phone 100 serves as a caller, the notifying unit 16 is configured to output an alerting signal and a status signal, that indicates a communication status of the transceiving device 3 via the display screen 18 and/or the speaker 20. For example, the communication status of the transceiving device 3 may be a status that the transceiving device 3 is turned off, that the transceiving device 3 is busy, or that the transceiving device 3 is not reachable.

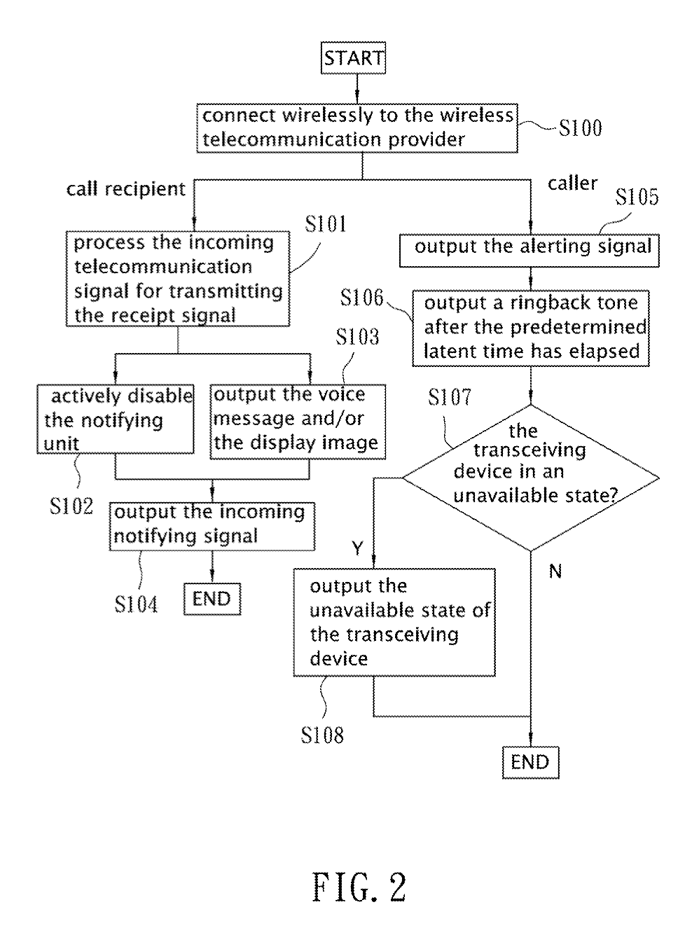

Reference is now made to FIG. 2, illustrating the first preferred embodiment of the method for reducing effect of electromagnetic radiation on a user of a mobile phone according to the present invention. It is noted that at the beginning of the method, the mobile phone 100 is connected wirelessly to the wireless telecommunication provider 2 in step S100.

When serving as a call recipient, the communication unit 10 of the mobile phone 100 is configured to receive the incoming telecommunication signal from the wireless telecommunication provider 2. The processing unit 12 of the mobile phone 100 is then configured to process the incoming telecommunication signal for transmitting the receipt signal via the communication unit 10 to the wireless telecommunication provider 2 in step S101.

Then, in step S102, the active delay unit 14 is operable to actively disable the notifying unit 16 from outputting the incoming notifying signal by a predetermined latent time. As a result, the notifying unit 16 of the mobile phone 100 does not output the incoming notifying signal within the predetermined latent time. In the case where the voice message and/or the display image are incorporated with the incoming telecommunication signal, the notifying unit 16 is configured to output the voice message and/or the display image via the speaker 20 and/or the display screen 18 in step S103. Therefore, after the user has finished listening to the voice message and/or viewing the display image, the duration, in which the electromagnetic radiation has a relatively higher flux, has elapsed. In some examples, the predetermined latent time is set to 3 seconds. The user can be made aware to refrain from, putting the mobile phone 100 near his/her head during the predetermined latent time. After the predetermined latent time has elapsed, the active delay unit 14 is operable to enable the notifying unit 16 to output the incoming notifying signal in step S104. As a result, the user can now answer the incoming call without exposure to unhealthy effect of the electromagnetic radiation having a relatively higher flux at the beginning of receipt of the incoming telecommunication signal, and the method is subsequently terminated.

When serving as a caller, the mobile phone 100 is operable to allow the user to dial the number for communicating with the transceiving device 3, and the notifying unit 16 of the mobile phone 100 is operable, in step S105, to output the alerting signal immediately after the user dials the number. The alerting signal may include one of a voice signal, a vibration signal and a display image. As a result, the user can be alerted to refrain from putting the mobile phone 100 near his/her head right after dialing.

When communication between the mobile phone 100 and the transceiving device 3 through the wireless telecommunication provider 2 has been established, the receipt signal is transmitted from the transceiving device 3 via the wireless telecommunication provider 2 to the communication unit 10 of the mobile phone 100. In step S106, the notifying unit 16 of the mobile phone 100 is operable to output a ringback tone after the predetermined latent time has elapsed. The object of this particular step S106 is as follows: If the transceiving device 3 (serving as the call recipient) is configured similarly as the mobile phone 100 and is operable to implement step S102, output of the notifying signal is to be delayed by the predetermined latent time. Then, in a case without step S106 for delaying the ringback tone, the mobile phone 100 may immediately output the ringback tone notifying the user right after the communication between the mobile phone 100 and the transceiving device 3 is established. The ringback tone may be sustained too long such that the user may assume that the number is not available and may hang up before the call is answered. Thus, in step S106, the start of outputting the ringback tone is delayed to avoid such instance from occurring.

In step S107, the processing unit 12 of the mobile phone 100 is operable to determine whether the transceiving device 3 is in an unavailable state (e.g., busy, device not operational, and voice mail, etc.) according to the receipt signal. When the determination is affirmative, the flow proceeds to step S108. Otherwise, the transceiving device 3 is deemed available, and the method is subsequently terminated.

In step S108, the notifying unit 16 of the mobile phone 100 is operable to output the unavailable state of the transceiving device 3 via the speaker 20, such that the user can be notified accordingly without having to put the mobile phone 100 near his/her head or to look constantly at the display screen 18. In some examples, when the transceiving device 3 is deemed available and the call, is answered, the voice content of the call is also outputted by the speaker 20 in the beginning of the call so as to better reduce exposure to the effect of electromagnetic radiation.

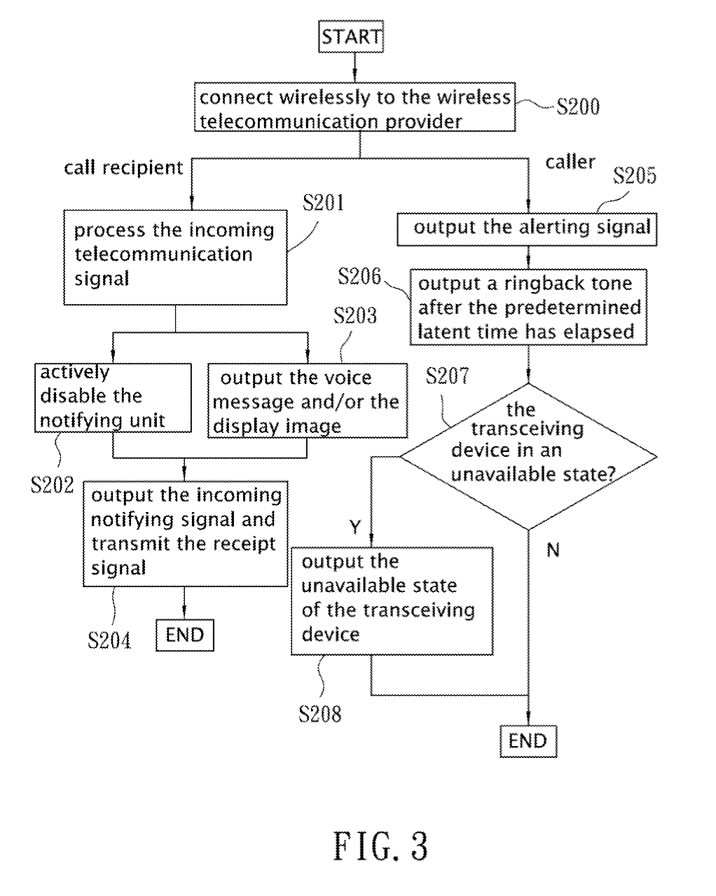

Reference is now made to FIG. 3, illustrating the second preferred embodiment of the method for reducing effect of electromagnetic radiation on a user of a mobile phone according to the present invention. The method of this embodiment is similar to the first embodiment. The main differences between this embodiment and the previous embodiment are described in as follows:

When serving as a call recipient, in step S204, the communication unit 10 of the mobile phone 100 is further operable to transmit the receipt signal after the predetermined latent time has elapsed. The object of step S204 is as the following: In a case without step S204 for delaying the receipt signal, the transceiving device 3 starts notifying the user thereof right after the communication between the mobile phone 100 and the transceiving device 3 is established (i.e., in step S201). However, due to the time delay in step S202, the user of the transceiving device 3 may have waited too long and may assume that the number is not available and may hang up before the call is answered. Thus, in step S204, transmission of the receipt signal to the wireless telecommunication provider 2 is delayed, in order to prevent such instance from occurring.

The second preferred embodiment has the same advantages as those of the first preferred embodiment.

To sum up, the abovementioned method of the present invention serves the purpose of preventing the user from putting the mobile phone 100 near his/her head during the time in which electromagnetic radiation emitted from the mobile phone 100 has a higher flux (i.e., when a number has just been dialed, or when an incoming call has just been received).

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for reducing effect, on a user of a mobile phone, of electromagnetic radiation emitted from the mobile phone, the mobile phone including a communication unit for communicating with a wireless telecommunication provider, a processing unit, an active delay unit and a notifying unit, said method comprising the following steps of:
when the communication unit of the mobile phone receives an incoming telecommunication signal from the wireless telecommunication provider, configuring the processing unit to process the incoming telecommunication signal;
configuring the active delay unit to actively disable the notifying unit by a predetermined latent time; and
configuring the active delay unit to enable the notifying unit to output an incoming notifying signal for notifying the user of an incoming call associated with the incoming telecommunication signal after the predetermined latent time has elapsed.

2. The method of claim 1, wherein the notifying signal includes at least one of a display image, a ring tone, and a vibration signal.

3. The method of claim 1, wherein the communication unit of the mobile phone is further configured to transmit a receipt signal, which indicates that the mobile phone has received the incoming telecommunication signal, to the wireless telecommunication provider after the predetermined latent time has elapsed.

4. The method of claim 1, wherein the communication unit of the mobile phone is further configured to receive the incoming telecommunication signal incorporated with a voice message from the wireless telecommunication provider, and the notifying unit is further configured to output the voice message before outputting the incoming notifying signal.

5. The method of claim 1, wherein the communication unit of the mobile phone is further configured to receive the incoming telecommunication signal incorporated with a display image from the wireless telecommunication provider, and the notifying unit is further configured to output the display image before outputting the incoming notifying signal.

6. A method for reducing effect, on a user of a mobile phone, of electromagnetic radiation emitted from the mobile phone, the mobile phone including a communication unit for communicating with a transceiving device through a wireless telecommunication provider, and a notifying unit, said method comprising the following step of:
configuring the notifying unit of the mobile phone to output an alerting signal immediately, after the user dials a number for communicating with the transceiving device using the mobile phone.

7. The method of claim 6, wherein the notifying unit of the mobile is configured to output a status signal that indicates a communication status of the transceiving device.

8. The method of claim 7, wherein the status signal includes one of a voice signal, a vibration signal and a display image.

9. The method of claim 6, further comprising the following step of:
when a signal indicating that communication between the mobile phone and the transceiving device through the wireless telecommunication provider has been established is received by the communication unit of the mobile phone, configuring the notifying unit of the mobile phone to output a ringback tone after a predetermined latent time has elapsed.
